(19) United States
(12) Patent Application Publication
(10) Pub. No.: US 2009/0272239 A1
(43) Pub. Date: Nov. 5, 2009

(54) Systems and methods for straight line sawing incorporating a pressure arm assembly

(76) Inventor: Wayne S. Boehme, Burlington, WI (US)

Correspondence Address: RYAN KROMHOLZ & MANION, S.C., POST OFFICE BOX 26618, MILWAUKEE, WI, 53226, US

(21) Appl. No.: 12/387,130

(22) Filed: Apr. 28, 2009

Related U.S. Application Data
(60) Provisional application No. 61/049,327, filed on Apr. 30, 2008.

(51) Int. Cl. B27B 25/06; B27B 27/08

(52) U.S. Cl. 83/13; 83/431; 83/436.2; 83/446; 83/468.2

(57) ABSTRACT

The invention has two main components: a straight edge board and a pressure arm assembly. When used together, the two components will allow a table saw operator to safely and accurately straight line rip crooked material, typically lumber, in one continuous pass. When used without the straight edge board, the pressure arm assembly will keep the material tight against the table saw's rip fence while rip sawing or performing additional sawing techniques.

### RELATED APPLICATIONS

This application claims the benefit of U.S. Provisional Patent Application Ser. No. 61/049,327, filed Apr. 30, 2008, and entitled “A device used to achieve a straight-line rip on one edge of crooked material or to keep material tight against a table saw's rip fence during various sawing techniques,” which is incorporated herein by reference.

### FIELD OF THE INVENTION

The present invention relates to systems and methods used to achieve a straight-line cut or rip on one edge of crooked material and/or to keep material tight against a table saw's rip fence during various sawing techniques.

### BACKGROUND OF THE INVENTION

The systems and methods of the present invention, while being easy to mount and adjust to different width materials, may prevent saw blade burn marks by allowing the operator to cut material, including crooked material, in one continuous pass through the table saw. A significant reduction in the potential for kick-back can result.

Devices adapted to accommodate straight line ripping on a table saw are limited in that they apply a downward pressure on the crooked material in order to hold the material in a fixed position relative to a movable platform. The devices are cumbersome in that they require multiple clamps to secure the crooked material in place. In addition, the devices provide no support or constant pressure to the material to be cut, including crooked material, while the material is passed over the table saw. The invention is an improvement over a feather board in range of movement, ease of mounting, and ability to apply consistent pressure to the material while using a table saw with rip fence.

The need remains for simple, cost-effective, and less complicated and cumbersome systems and methods for accommodating straight line ripping on a table saw, including the ability to provide support and/or constant pressure to the material to be cut, including crooked material, while the material is passed over the table saw.

### SUMMARY OF THE INVENTION

The invention comprises systems and methods for achieving a straight-line cut or rip on one edge of a material to be cut and/or to keep the material tight against a table saw's rip fence during various sawing techniques.

One aspect of the invention provides a system for cutting material. The system can comprise a straight edge board having a length and width. The board has at least one straight edge adjuster, the adjuster being movably attached to the board in generally the same plane as the board. The adjuster may be adjustable between a retracted position and an extended position, such that in the extended position the adjuster is able to extend from the board to contact a material to be cut during a cutting operation. The extended position may be generally perpendicular to the length of the board. The board may also have a straight edge board stop, the board stop extending beyond an edge of the board to control the movement and location of the material to be cut during the cutting operation. The system also comprises a pressure arm assembly, the pressure arm assembly adapted to apply a pressure to the material to be cut during the cutting operation. The pressure arm assembly comprises a main shaft and at least one pressure arm having a first end and a second end, with the first end mounted to the main shaft, and a pressure arm roller mounted to the second end. The pressure arm roller may be adapted to contact the material to be cut during the cutting operation and to rotate in generally the same plane as the board so as to allow the pressure arm roller to rotate as the material to be cut during the cutting operation is advanced past the pressure arm roller.

In one embodiment, in the retracted position, the adjuster does not contact the material to be cut.

In another embodiment, the board stop is attached to one end of the length of the board.

In yet another embodiment, the first end of the pressure arm is pivotally mounted to the main shaft.

In yet another embodiment, the system may further include at least one pressure arm tension device, with one end of the pressure arm tension device releasably coupled to the main shaft, and the other end of the pressure arm tension device releasably coupled to the pressure arm. The pressure arm tension device may comprise a spring.

In yet another embodiment, the pressure arm assembly may comprise two or more pressure arms, with each pressure arm having a pressure arm roller mounted to the second end.

In yet another embodiment, the system further comprises a locking mechanism to hold the pressure arm assembly securely in place and to allow for adjustment of the position of the pressure arm assembly relative to the position of the material to be cut during the cutting operation. The locking mechanism may further comprise a fence guide lock device and a lock handle, the fence guide lock device and the lock handle adapted to apply a pressure to a table saw's fence guide rail to hold the pressure arm assembly securely in place.

An additional aspect of the invention provides a system for straight line cutting an edge of a crooked material. The system may comprise a straight edge board having a length and width. The board may have at least two straight edge adjusters, the adjusters being movably attached to the board in generally the same horizontal plane as the board. The adjusters may be adjustable between a retracted position where the adjusters do not contact the crooked material, and an extended position, such that in the extended position the adjusters are able to extend from the board to contact the crooked material, the extended position being generally perpendicular to the length of the board. The system may include a pressure arm assembly, the pressure arm assembly adapted to apply a pressure to the crooked material during a cutting operation. The pressure arm assembly may comprise a main shaft and at least one pressure arm having a first end and a second end, with the first end mounted to the main shaft, and a pressure arm roller mounted to the second end. The pressure arm roller may be adapted to contact the crooked material during the cutting operation and to rotate in generally the same plane as the board so as to allow the pressure arm roller to rotate as the crooked material is advanced past the pressure arm roller.

In one embodiment, the board may further include a straight edge board stop, the board stop extending beyond an edge of the board to control the movement and location of the crooked material during the cutting operation.

In another embodiment, the system may further include at least one pressure arm tension device, with one end of the pressure arm tension device releasably coupled to the main shaft, and the other end of the pressure arm tension device releasably coupled to pressure arm.

In yet another embodiment, the system may further comprise a locking mechanism to hold the pressure arm assembly securely in place and to allow for adjustment of the position of the pressure arm assembly relative to the position of an edge of the crooked material.

Yet an additional aspect of the invention provides a method of cutting a piece of material on a table saw. The method may include the steps of providing a straight edge board including at least one straight edge adjuster and a straight edge board stop, positioning the straight edge board on a table saw having a saw blade and a fence, positioning a piece of material to be cut edge to edge with the straight edge board, butting an end of the material to be cut against the board stop at an end of the straight edge board, positioning the straight edge adjuster so it comes in contact with the material to be cut to bridge any gaps between the straight edge board and the material to be cut, securing the position of the straight edge adjuster, providing a pressure arm assembly comprising a main shaft and at least one pressure arm having a first end and a second end, with the first end mounted to the main shaft, and a pressure arm roller mounted to the second end, positioning the pressure arm assembly on the table saw so the pressure arm roller extends past an edge of the material to be cut, locking the pressure arm assembly in place, feeding the straight edge board and the material to be cut into the pressure arm assembly and the table saw, so as the material to be cut and the straight edge board are feeding into the pressure arm assembly and the table saw, the material to be cut is contacting the pressure arm roller that is mounted to the pressure arm, and cutting the material while the material is being passed against the pressure arm assembly and past the table saw blade.

In one embodiment, the method may further include measuring the width of the combined material to be cut and the straight edge board in order to determine the position of the table saw fence.

In another embodiment, the method may further include positioning the pressure arm assembly on the table saw so the pressure arm roller extends past an edge of the material to be cut by approximately one-third to one-half a diameter of the pressure arm roller.

In yet another embodiment, the method may further include locking the pressure arm assembly in place by engaging a locking mechanism.

In yet another embodiment, the pressure arm roller may rotate as the material to be cut is fed into the saw.

In yet another embodiment, the pressure arm may pivot causing expansion of a pressure arm tension device. The pressure arm tension device may return the pressure arm with the pressure arm roller back to their original position after the material to be cut has passed the pressure arm roller.

The systems and methods of the present invention uses a simple camming mechanism to securely lock the device onto the table saw's rip fence guide rail for use when performing standard table saw ripping and other sawing techniques which use the table saw's rip fence. A straight line rip guide board can be added to the device for use with straight line ripping. The device has pressure arms, calibrated springs, and non-marring rollers, in order to apply constant pressure to the material to keep it tight against the table saws rip fence. This allows the material to be fed into the saw with one continuous movement.

Other features and advantages of the invention shall be apparent based upon the accompanying description, drawings, and claims.

### BRIEF DESCRIPTION OF THE DRAWINGS

FIG. 1 is a top view of an exemplary embodiment of a straight edge board with a crooked board in position next to the straight edge board, and an exemplary embodiment of a pressure arm assembly in position on a table saw.

FIG. 2 is a side view of an embodiment of an adjuster of the straight edge board shown in FIG. 1.

FIG. 3 is a top view of an embodiment of an adjuster of the straight edge board, as shown in FIG. 2, showing one adjuster in a retracted position and one adjuster in an extended position.

FIG. 4 is a top view of an embodiment of a pressure arm assembly shown in FIG. 1, with the main shaft including pressure arms, pressure arm rollers, and pressure arm springs, and the fence guide angle and the cam lock/handle are shown to illustrate the locking mechanism on the table saw fence rail.

FIG. 5 is a side view of the pressure arm assembly shown in FIG. 4, showing the locking device represented with the cam lock/handle, cam lock/foot G, and the fence guide lock angle, and the main shaft showing positions and attachment of the spring retainer towers, as well as attachment of the pressure arm springs to the spring retaining towers.

FIG. 6 is a front view of the pressure arm assembly shown in FIG. 4, with the springs removed for clarity, and showing the pressure arm and pressure arm roller with the pressure arm roller axel bolt, and the spring retaining towers with the pressure arm pivot bolts.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The present invention relates to devices and methods used to achieve a straight-line rip on one edge of crooked material and/or to keep material tight against a table saw's rip fence during various sawing techniques.

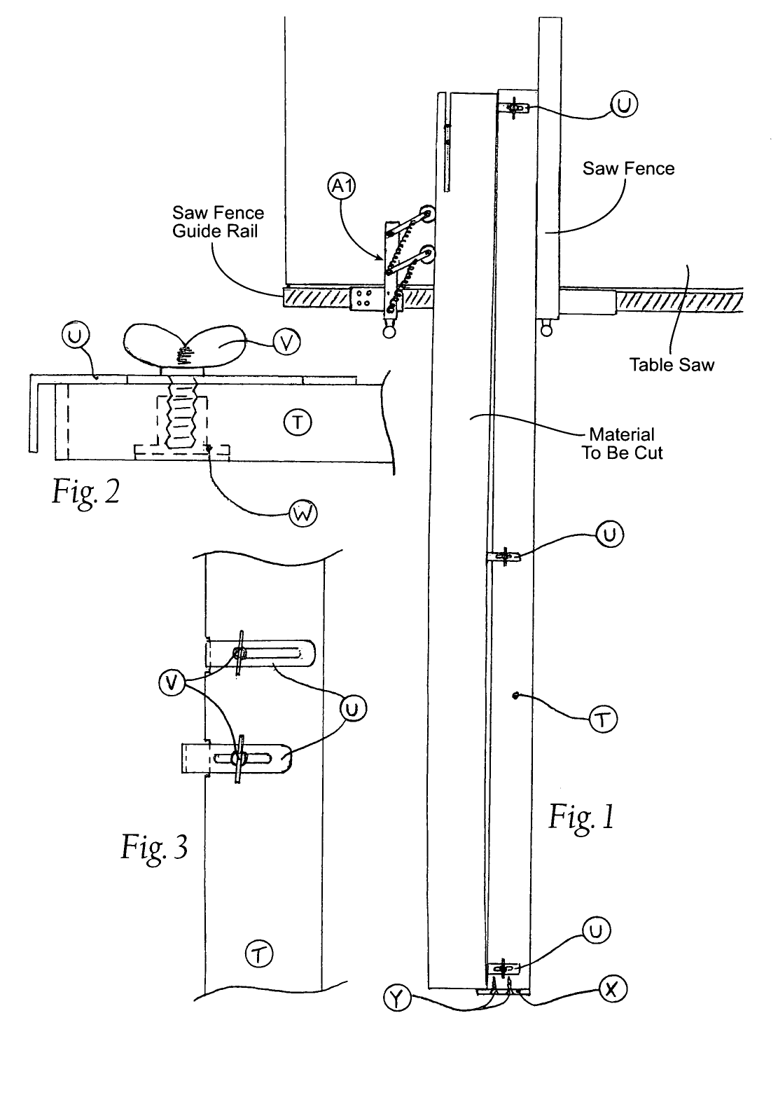

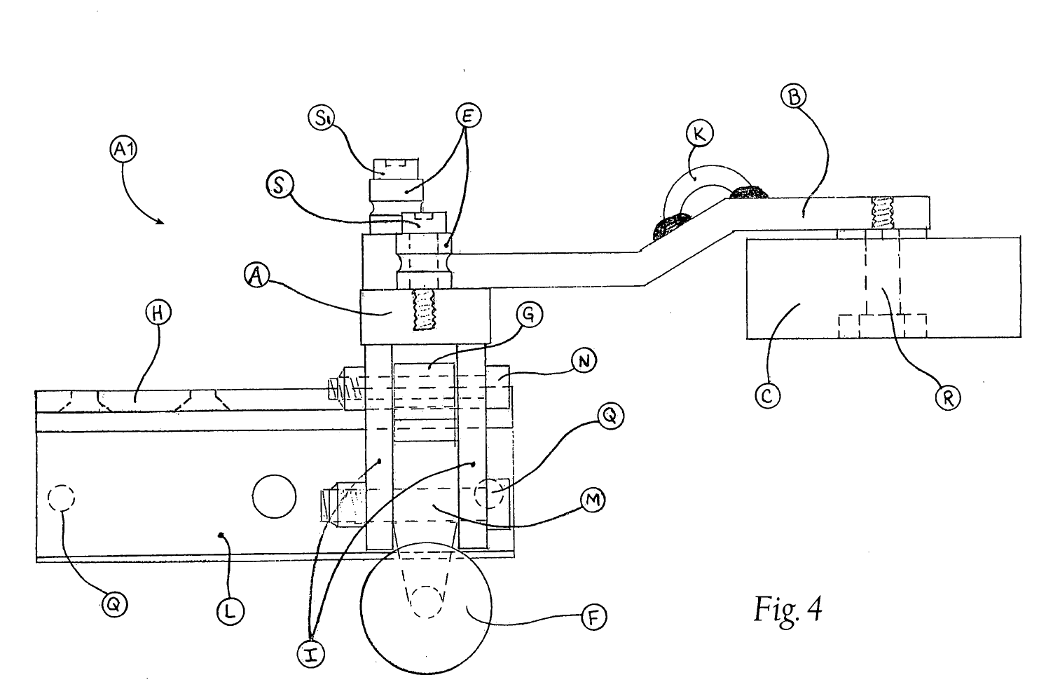

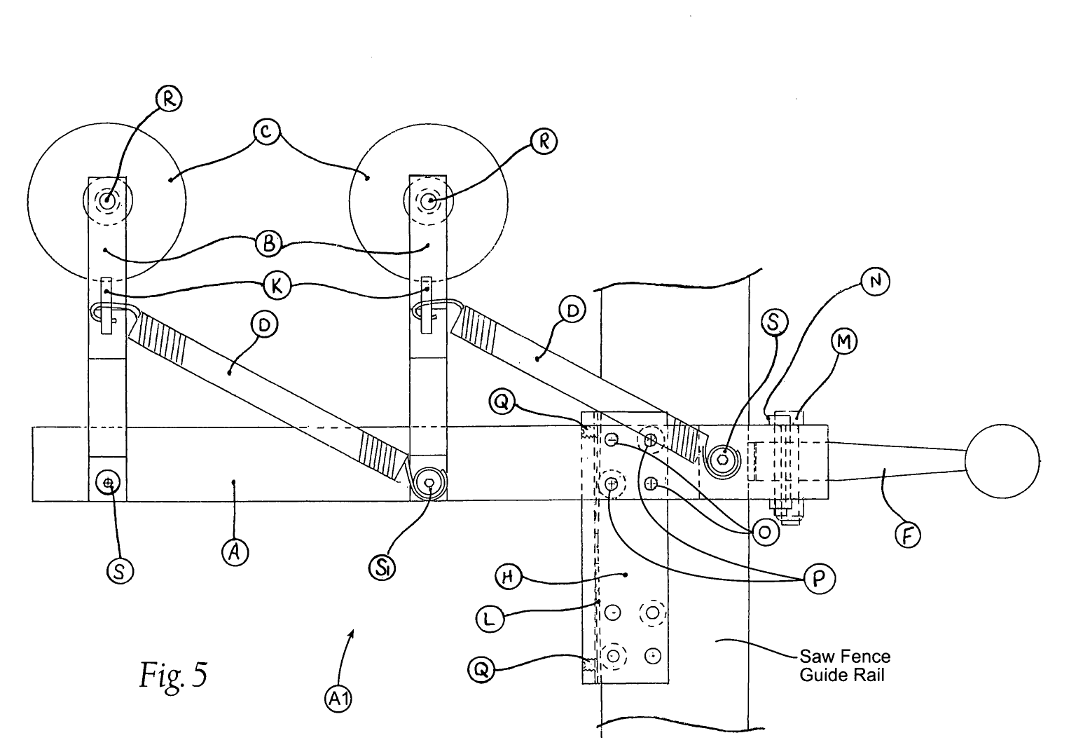

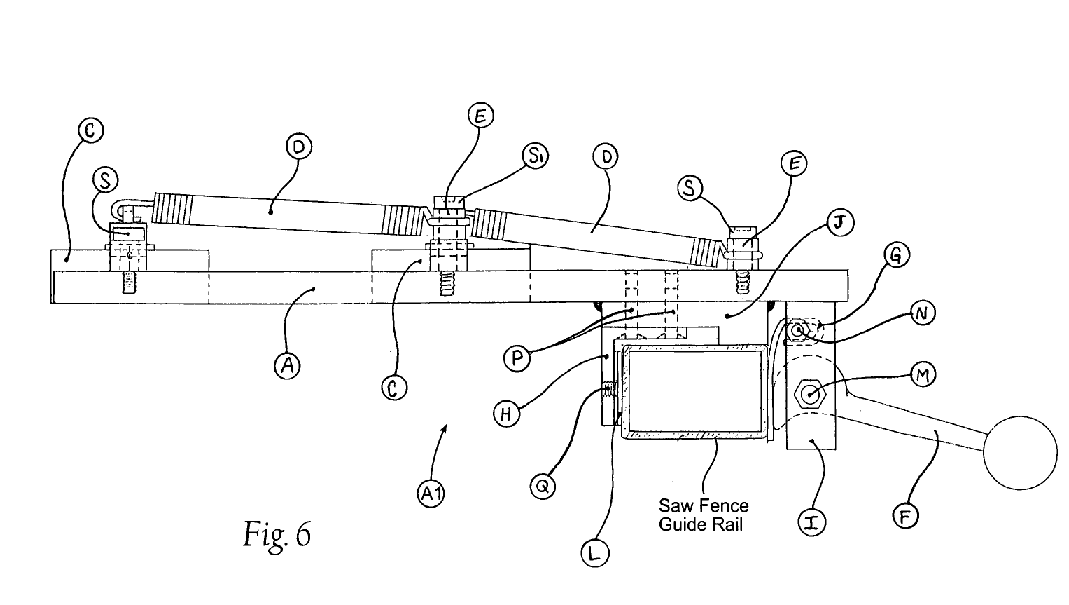

As can be seen in the Figures, and specifically referring to FIGS. 1 through 6, the devices and methods of the present invention can include one or more of the following components:

A Main Shaft: The main shaft may be the primary component to which the other parts of the pressure arm assembly A1 are attached or otherwise coupled. Elements of the main shaft A may be the cam lock/handle and cam lock foot brackets I. Two pressure arm pivot bolt holes and one stationary spring retaining tower bolt hole may be drilled and tapped into the main shaft A for the mounting of the pressure arms B and spring retaining towers E. Two holes locating the fence guide lock angle H may be machined or otherwise formed into the main shaft A and held with two roll pins O. The cam lock/handle and cam lock foot brackets I may be drilled for mounting bolts M and N.

B Pressure Arms: The offset pressure arms B may be mounted and can pivot at one end on the pressure arm pivot bolts S, S1. Machined or otherwise formed into the other end of the pressure arm B may be a drilled and tapped hole for the mounting of the pressure arm roller axle bolt R, which may be used to mount the pressure arm roller C. The pressure arms B may also have a pressure arm spring retainer K welded or otherwise coupled to them. This is used to secure one end of the pressure arms springs D. The pressure arms B may work together with the pressure arm springs D and pressure arm rollers C to apply pressure to the material to be cut, keeping the material tight to the table saw's rip fence and then return the pressure arms B to their original position upon completion of the saw cut. When the material is fed into the pressure arm assembly A1, the pressure arms B are forced to pivot on the pressure arm pivot bolts S, S1, causing the pressure arm springs D to expand, creating a pressure force to be applied to the material. It is to be appreciated that the pressure arms may be flexible so as to eliminate use of the pressure arm springs.

C Pressure Arm Rollers: The pressure arm rollers C may be attached to the pressure arms B with the pressure arm roller axle bolts R. The pressure arm rollers C provide a smooth, uniform, non-marring surface on which to apply the pressure to the material to be cut, and may be made of plastic or rubber materials, as non-limiting examples. The pressure arm rollers C may be configured to freely rotate in a first direction (the direction that the material to be ripped is going to be fed, and to rotate with resistance in the opposite direction, or not rotate at all in the opposite direction, to reduce kick back.

D Pressure Arm Springs: The pressure arm springs D may be used to provide a constant and measured amount of pressure or tension to the pressure arm rollers C. The pressure arm springs D allow for a wide range of pressure arm B movement. The pressure arm springs D may return the pressure arms B to their original position upon completion of the saw cut. One end of the pressure arm spring D may be attached to the pressure arm spring retainer K which may be welded or otherwise coupled to the pressure arms B. The other end of the pressure arm spring D may be attached to a spring retaining tower E. It is to be appreciated that other devices may be used in place of a spring, such as and device or system capable of storing mechanical energy, and/or hydraulics or pneumatics, or any combination, as non-limiting examples.

E Spring Retaining Towers: The spring retaining towers may be used to provide a secure mount to one end of the pressure arm springs D. These spring retaining towers E may have a groove machined or otherwise formed into the outside surface to provide a “lock” for the pressure arm springs D end. The spring retaining towers E may be fastened to the main shaft A using the pressure arm pivot bolts S, S1.

F Cam Lock/Handle: With the camming action, the cam lock/handle F may be adapted to provide a strong, tight, reliable locking mechanism to hold the pressure arm assembly A1 securely in place and allow for easy adjustments. The cam lock/handle F may be attached to the cam lock handle and cam lock foot brackets I, using the cam lock handle nut and bolt M.

G Cam Lock Foot: May be used as a wear plate between the cam lock/handle F and table saw's rip fence guide rail. This prevents excessive wear to the table saw's rip fence guide rail. The cam lock foot G may be attached to the cam lock/handle and cam lock foot brackets I with the cam lock foot nut and bolt N.

H Fence Guide Lock Angle: May be used along with the cam lock/handle F and the cam lock foot G to complete the locking mechanism for the pressure arm assembly A1. The fence guide lock angle H may have an adjustable pressure plate L plug welded or otherwise coupled to it along with two (or more or less) drilled and tapped holes for two cam lock/handle tension screws Q to provide for tension adjustment on the lock mechanism. The fence guide lock angle H may be located and mounted onto the spacer block J using two flat head machine screws P and two roll pins O. The fence guide lock angle H can be located and mounted on the left or right side of the main shaft A so the pressure arm assembly A1 can be used on the left or right hand side of the table saw's rip fence.

I Cam Lock/Handle and Cam Lock Foot Brackets: These brackets may be machined or otherwise formed into the main shaft A. The cam lock/handle and cam lock foot brackets I may be used to locate and mount the cam lock/handle F and the cam lock foot G to the pressure arm assembly A1.

J Spacer Block: The spacer block may be machined or otherwise formed to provide for the location and attachment of the fence guide lock angle H with two roll pins O and two flat head machine screws P. The spacer block J may be machined or otherwise formed to allow the main shaft A to make contact with the table saw's guide rail. The spacer block J may be welded or otherwise coupled to the main shaft A.

K Pressure Arm Spring Retainers: The pressure arm spring retainers K may be ¼″ diameter steel round stock, bent with approximately a 3/16″ radius curvature, for example. These may be welded or otherwise coupled to the pressure arm B, allowing for one end of the pressure arm springs D to be attached.

L Adjustable Pressure Plate: The adjustable pressure plate may be a steel plate which may be plug welded or otherwise coupled in the center of the adjustable pressure plate L to the fence guide lock angle H to enable pressure adjustments to be made to the lock mechanism.

M Cam Lock/Handle Nut and Bolt: May be used to hold the cam lock/handle F to the cam lock/handle and cam lock foot brackets I in order to allow the cam lock/handle F to pivot in the cam lock handle and cam lock foot brackets I.

N Cam Lock Foot Nut and Bolt: Is used to locate the cam lock foot G in the cam lock/handle and cam lock foot brackets I to permit cam lock foot G movement.

O Roll Pins: Two roll pins may be used to locate the fence guide lock angle H to the spacer block J and the main shaft A.

P Flat Head Machine Screws: Two flat head machine screws may be used to attach the fence guide lock angle H to the spacer block J.

Q Cam Lock/Handle Tension Screws: Two cam lock/handle tension screws, which may be ¼-28× 5/16″ long alloy steel screws, for example, may be used to adjust the locking pressure on the lock mechanism.

R Pressure Arm Roller Axle Bolts: The ⅜×¾″ long alloy steel shoulder bolts, for example, may be attached to the pressure arms B and provide an axle for the pressure arm rollers C.

S Pressure Arm Pivot Bolts: These ⅜×⅝″ long alloy steel shoulder bolts, for example, may be used to attach one end of the pressure arm B to the main shaft A and to attach one spring retaining tower E to the main shaft A. It is to be appreciated that the pressure arm pivot bolts may positioned generally in the center of the main shaft A so as to allow pressure arm rollers C to be mounted on the left side of the main shaft A. In this configuration, the main shaft A may be mounted to the left side of the fence guide lock angle.

S1 Pressure Arm Pivot Bolt: The ⅜×1¼″ long alloy steel shoulder bolt, for example, may be used to attach one pressure arm B and one pressure arm spring retaining tower E to the main shaft A.

T Straight Edge Board: The straight edge board T may be used with the pressure arm assembly A1 to straight line rip one edge of crooked material. The straight edge board T may have a board stop X attached to one end, using two board stop screws Y. Machined or otherwise formed into the straight edge board T may be notches and mounting holes for the straight edge adjusters U. The holes for the adjusters may be drilled or otherwise formed for the installation of the straight edge adjuster tee nuts W. The straight edge board T may be supplied by the user and may need to be machined or otherwise formed to fit the straight edge adjuster tee nuts W, board stop X, and notches for the straight edge adjusters U.

U Straight Edge Adjusters: The straight edge adjusters may be attached to the straight edge board T with the use of the straight edge adjuster thumb screws V and the straight edge adjuster tee nuts W. The straight edge adjusters U may be machined or otherwise formed with an elongated slot to allow for adjustment, enabling the straight edge adjusters U to be positioned in order to make contact with the crooked material to be straight line ripped. The straight edge adjuster thumb screws V may be then tightened securely in position.

V Straight Edge Adjuster Thumb Screws: These may be used to adjust as necessary and securely fasten the straight edge adjusters U to the straight edge board T.

W Straight Edge Adjuster Tee Nuts: These may be standard ⅜-16″ tee nuts, for example. They may be used with the straight edge adjuster thumb screws V to fasten and locate the straight edge adjusters U in place.

X Board Stop: The board stop may be attached to one end of the straight edge board T, using two board stop screws Y. The board stop may be used to control the movement and location of the material to be straight line ripped.

Y Board Stop Screws: The board stop screws may be 1⅝″ long screws, for example, used to attach the board stop X to one end of the straight edge board T.

In the construction of the invention, one or more of the following parts may be fabricated from 1018 mild steel, although it is to be appreciated that other materials known to one of ordinary skill in the art may be used for the intended purpose:

A The Main Shaft

B Pressure Arms

G Cam Lock Foot

J Spacer Block

K Pressure Arm Spring Retainers

L Adjustable Pressure Plate

U Straight Edge Adjusters

Alternative materials for these components could also be fabricated from (but not limited to) the following: Hot or Cold Rolled Carbon Steel, Alloy Steels, Cast Steel, Cast Iron, Aluminum, Cast Aluminum, Stainless Steel, Copper, Brass, Bronze, Titanium, Magnesium, Gold, Silver, Wood, Hard Plastics, and Fiberglass.

The Pressure Arm Rollers C may be fabricated from acetyl plastic, for example. Other materials that could be used (but not limited to) include: wood, other plastics, nylon, rubber, wood composite materials, fiberglass, PVCs, and polyurethane.

The Pressure Arm Springs D may be purchased as hard drawn, zinc coated spring steel, with 4.04 PPIP tension. An alternative material that could be used is stainless steel, for example.

The Spring Retaining Towers E may be fabricated from 1020 drawn over mandrel tubing, for example. This part could also be fabricated from (but not limited to) the following: Hot or Cold Rolled Carbon Steel, Alloy Steels, Cast Steel, Cast Iron, Aluminum, Cast Aluminum, Stainless Steel, Copper, Brass, Bronze, Titanium, Magnesium, Gold, Silver, Wood, Hard Plastics, and Fiberglass.

The Cam Lock/Handle F may be made from cast steel, for example. This part could also be fabricated from (but not limited to) the following: Hot or Cold Rolled Carbon Steel, Alloy Steels, Cast Iron, Aluminum, Cast Aluminum, Stainless Steel, Copper, Brass, Bronze, Titanium, Magnesium, Gold, Silver, Wood, Hard Plastics, and Fiberglass.

The Fence Guide Lock Angle H may be fabricated from hot rolled angle iron, for example. Alternative materials for these components could also be fabricated from (but not limited to) the following: Hot or Cold Rolled Carbon Steel, Alloy Steels, Cast Steel, Cast Iron, Aluminum, Cast Aluminum, Stainless Steel, Copper, Brass, Bronze, Titanium, Magnesium, Gold, Silver, Wood, Hard Plastics, and Fiberglass.

The Cam Lock/Handle Nut and Bolt M may be purchased as a Grade 2 bolt with a nylon insert lock nut, for example. An alternative material could be either a Grade 5 or Grade 8 bolt with nut and lock washer, a rivet, or a welded pin, for example.

The Cam Lock Foot Nut and Bolt N may be purchased as a Grade 2 bolt with a nylon insert lock nut, for example. An alternative material could be either a Grade 5 or Grade 8 bolt with nut and lock washer, a rivet, or a welded pin.

The Pressure Arm Roller Axle Bolt R may be a ⅜×¾″ long alloy shoulder bolt, for example. It could also be riveted or otherwise coupled using known means.

The Straight Edge Board T may be fabricated from wood, for example. It could also be made from (but not limited to): Drawn Aluminum, Plastics, Fiberglass, and Wood Composite.

The Board Stop X may be fabricated from wood, but the following materials could also be used: Wood Composite, Fiberglass, Plastic, and Aluminum, for example.

The Board Stop Screws Y may be purchased 1⅝″ long screws, for example.

The straight line ripping of a crooked piece of material may use both the straight edge board T and the pressure arm assembly A1.

An exemplary embodiment of a method of use of the invention or components of the invention may include one or more of the following steps. It is to be appreciated that the steps may vary in order or content depending on the specific application.

Step 1: Depending on the length of the material, extension tables may need to be utilized with the table saw.

Step 2: Position the straight edge board T on the extension tables.

Step 3: Position the crooked piece of material edge to edge with the straight edge board T.

Step 4: Butt the end of the crooked material against the straight edge board stop X at the end of the straight edge board T.

Step 5: Position the straight edge adjusters U so they come in contact with the crooked material to bridge any gaps between the straight edge board T and the crooked material. Then tighten the straight edge adjuster thumb screws V.

Step 6: Measure the width of the two boards in order to determine the position of the table saw fence. Lock the table saw fence in the pre-determined location.

Step 7: Position the straight edge board T and the crooked material on the front edge of the table saw bed.

Step 8: Position the pressure arm assembly A1 on the table saw so the pressure arm rollers C extend past the edge of the crooked material by approximately one-third to one-half the diameter of the pressure arm rollers C.

Step 9: Lock the pressure arm assembly A1 in place by pushing down on the cam lock/handle F.

Step 10: Start the saw and stand at the far end of the two boards and begin to feed the straight edge board T and material into the pressure arm assembly A1.

Step 11: As the material and straight edge guide board T are fed into the pressure arm assembly A1 and table saw, the material should contact the pressure arm rollers C which are connected to the pressure arms B.

Step 12: The pressure arm rollers C may rotate as the material is fed into the saw. The pressure arms B may pivot on the pressure arm pivot bolts S and S1, causing the expansion of the pressure arm springs D.

Step 13: The pressure arm springs D may be attached to the spring retaining towers E at one end while the other end may be attached to the pressure arms B with the pressure arm spring retainers K. The expansion of the pressure arm springs D creates a force to be applied, through the pressure arms B and pressure arm rollers C, to the edge of the material to be straight line ripped.

Step 14: This pressure forces the material and straight edge board T tight against the table saws rip fence throughout the entire saw cut. The operator may feed the straight edge board T and material to be straight line ripped through the table saw in one continuous pass.

Step 15: As the material passes through the pressure arm assembly A1, the pressure arm springs D may return the pressure arms B with the pressure arm rollers C back to their original position, completing the process.

It may not be necessary to use the straight edge board T while performing standard table saw ripping and other table sawing techniques, such as rabbiting, grooving, beveling, dadoing, moulding, etc. which use the table saw's rip fence. The interaction of the components would remain the same.

The straight edge board of the invention can be structured from material other than wood, which was the material used in one embodiment of the invention. Instead of tee nuts L, steel or brass threaded inserts may be used. With a fiberglass or aluminum straight edge board T, the tee nuts L can be replaced with female threads built into the straight edge board T. The board stop V can be made to snap into place on either end of the straight edge board T, or may be an integral component. Female threads can be designed into the ends of the straight edge board T in order to screw or bolt the board stop V into place. On the pressure arm assembly A1 of the invention, many other materials can be used as explained later. The pressure arms B can be riveted or welded with the use of a pin to the main shaft A instead of using a pressure arm pivot bolt S, S1.

The pressure arm rollers C can be attached to the pressure arm B by riveting or welding a pin instead of using pressure arm roller axle bolts R. The spring retaining tower E nearest the lock mechanism can be riveted or welded with the use of a pin instead of mounting with the use of pressure arm pivot bolt S. The spacer block X and the main shaft A can be fabricated from a single billet of material instead of being welded to the main shaft A as used in one embodiment of the invention. The space block X can be bolted to the main shaft A instead of welded. Cam lock/handle nut and bolt M and cam lock foot nut and bolt N can be attached with a rivet or with a welded pin to the cam lock/handle bracket I, which may be machined or otherwise formed into the main shaft A. The adjustable pressure plate L which may be plug welded to the fence guide lock angle H can also be riveted, bolted, or edge welded to the fence guide lock angle H.

The pressure arm assembly lock mechanism can be constructed to fit many different table saw guide rails. The straight edge board T and the pressure arm assembly A1 may be assembled to accomplish straight line ripping and other sawing techniques on either the left hand or right hand side of the table saws rip fence.

For the straight line ripping objective of this invention, both the straight edge board T and the pressure arm assembly A1 may be utilized. A crooked piece of material, typically lumber but not limited to lumber, is positioned along side the straight edge board T. The table saw's rip fence may be positioned at the determined location and locked in place. The pressure arm assembly A1 may then be located and locked in position on the table saw. The material to be straight-line ripped and the straight edge board T are both fed into the pressure arm assembly A1 with the use of pivoting pressure arms, pressure arm springs, and pressure arm rollers. The pressure arm assembly A1 applies a consistent pressure to the material, forcing the material and the straight edge board T tight against the table saws rip fence throughout the entire saw cut, allowing the material and straight edge board T to be fed into the saw with one non-stop movement.

For standard table saw ripping or for performing other table sawing techniques which use the table saw's rip fence, the straight edge board T may not be used. The positioning and interaction of the pressure arm assembly components would remain the same, applying pressure to the material to be cut, forcing the material tight against the table saw's rip fence throughout the sawing operation.

The pressure arm assembly portion of the invention may be used on additional woodworking equipment, such as a router table, shaper table, radial arm saw table, jointer table or overhead router table, to keep the material to be cut tight against the guide rail fence.

The pressure arm assembly portion of the invention can be used on other woodworking equipment. The mounting mechanism of the invention may need to be modified to fit other equipment in order to achieve the objective of keeping the material tight against a guide rail fence. The straight edge board T can be used along with the pressure arm assembly A1 on a radial arm saw, which is set up for ripping.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A system comprising:
a straight edge board having a length and width, the board having at least one straight edge adjuster, the adjuster being movably attached to the board in generally the same plane as the board, the adjuster being adjustable between a retracted position and an extended position, such that in the extended position the adjuster is able to extend from the board to contact a material to be cut during a cutting operation, the extended position being generally perpendicular to the length of the board, the board having a straight edge board stop, the board stop extending beyond an edge of the board to control the movement and location of the material to be cut during the cutting operation, and
a pressure arm assembly, the pressure arm assembly adapted to apply a pressure to the material to be cut during the cutting operation, the pressure arm assembly comprising a main shaft and at least one pressure arm having a first end and a second end, with the first end mounted to the main shaft, and a pressure arm roller mounted to the second end, the pressure arm roller adapted to contact the material to be cut during the cutting operation and to rotate in generally the same plane as the board so as to allow the pressure arm roller to rotate as the material to be cut during the cutting operation is advanced past the pressure arm roller.

2. A system according to claim 1:
wherein in the retracted position, the adjuster does not contact the material to be cut.

3. A system according to claim 1:
wherein the board stop is attached to one end of the length of the board.

4. A system according to claim 1:
wherein the first end of the pressure arm is pivotally mounted to the main shaft.

5. A system according to claim 1:
further including at least one pressure arm tension device, with one end of the pressure arm tension device releasably coupled to the main shaft, and the other end of the pressure arm tension device releasably coupled to the pressure arm.

6. A system according to claim 5:
wherein the pressure arm tension device comprises a spring.

7. A system according to claim 1:
wherein the pressure arm assembly comprises two or more pressure arms, with each pressure arm having a pressure arm roller mounted to the second end.

8. A system according to claim 1:
further comprising a locking mechanism to hold the pressure arm assembly securely in place and to allow for adjustment of the position of the pressure arm assembly relative to the position of the material to be cut during the cutting operation.

9. A system according to claim 8:
wherein the locking mechanism further comprises a fence guide lock device and a lock handle, the fence guide lock device and the lock handle adapted to apply a pressure to a table saw's fence guide rail to hold the pressure arm assembly securely in place.

10. A system for straight line cutting an edge of a crooked material, the system comprising:
a straight edge board having a length and width, the board having at least two straight edge adjusters, the adjusters being movably attached to the board in generally the same horizontal plane as the board, the adjusters being adjustable between a retracted position where the adjusters do not contact the crooked material, and an extended position, such that in the extended position the adjusters are able to extend from the board to contact the crooked material, the extended position being generally perpendicular to the length of the board, and
a pressure arm assembly, the pressure arm assembly adapted to apply a pressure to the crooked material during a cutting operation, the pressure arm assembly comprising a main shaft and at least one pressure arm having a first end and a second end, with the first end mounted to the main shaft, and a pressure arm roller mounted to the second end, the pressure arm roller adapted to contact the crooked material during the cutting operation and to rotate in generally the same plane as the board so as to allow the pressure arm roller to rotate as the crooked material is advanced past the pressure arm roller.

11. A system according to claim 10:
wherein the board further includes a straight edge board stop, the board stop extending beyond an edge of the board to control the movement and location of the crooked material during the cutting operation.

12. A system according to claim 10:
further including at least one pressure arm tension device, with one end of the pressure arm tension device releasably coupled to the main shaft, and the other end of the pressure arm tension device releasably coupled to pressure arm.

13. A system according to claim 10:
further comprising a locking mechanism to hold the pressure arm assembly securely in place and to allow for adjustment of the position of the pressure arm assembly relative to the position of an edge of the crooked material.

14. A method of cutting a piece of material on a table saw, the method comprising:
providing a straight edge board including at least one straight edge adjuster and a straight edge board stop,
positioning the straight edge board on a table saw having a saw blade and a fence,
positioning a piece of material to be cut edge to edge with the straight edge board,
butting an end of the material to be cut against the board stop at an end of the straight edge board,
positioning the straight edge adjuster so it comes in contact with the material to be cut to bridge any gaps between the straight edge board and the material to be cut,
securing the position of the straight edge adjuster,
providing a pressure arm assembly comprising a main shaft and at least one pressure arm having a first end and a second end, with the first end mounted to the main shaft, and a pressure arm roller mounted to the second end,
positioning the pressure arm assembly on the table saw so the pressure arm roller extends past an edge of the material to be cut,
locking the pressure arm assembly in place,
feeding the straight edge board and the material to be cut into the pressure arm assembly and the table saw, so as the material to be cut and the straight edge board are feeding into the pressure arm assembly and the table saw, the material to be cut is contacting the pressure arm roller that is mounted to the pressure arm, and
cutting the material while the material is being passed against the pressure arm assembly and past the table saw blade.

15. A method according to claim 14:
further including measuring the width of the combined material to be cut and the straight edge board in order to determine the position of the table saw fence.

16. A method according to claim 14:
further including positioning the pressure arm assembly on the table saw so the pressure arm roller extends past an edge of the material to be cut by approximately one-third to one-half a diameter of the pressure arm roller.

17. A method according to claim 14:
further including locking the pressure arm assembly in place by engaging a locking mechanism.

18. A method according to claim 14:
wherein the pressure arm roller rotates as the material to be cut is fed into the saw.

19. A method according to claim 14:
wherein the pressure arm pivots causing expansion of a pressure arm tension device.

20. A method according to claim 19:
wherein the pressure arm tension device returns the pressure arm with the pressure arm roller back to their original position after the material to be cut has passed the pressure arm roller.
